(19) United States
(12) Patent Application Publication
(10) Pub. No.: US 2024/0309125 A1
(43) Pub. Date: Sep. 19, 2024

(54) POLYETHYLENE FOR USE IN THE PRODUCTION OF CROSSLINKED POLYETHYLENE (PEX)

(71) Applicant: BOREALIS AG, Vienna (AT)

(72) Inventors: Sara Cascone, Linz (AT); Elena Pomakhina, Linz (AT)

(21) Appl. No.: 18/575,941

(22) PCT Filed: Jul. 7, 2022
(86) PCT No.: PCT/EP2022/068950

§ 371 Date: Jan. 2, 2024

(30) Foreign Application Priority Data
Jul. 8, 2021 (EP) 21184421.2

(51) Int. Cl. C08F 10/02; C08F 4/24; C08J 3/24; C08J 7/02

(52) U.S. Cl. CPC C08F 10/02; C08F 4/24; C08J 3/247; C08J 7/02; C08J 2323/04

(57) ABSTRACT

A polyethylene (PE) for the production of crosslinked polyethylene (PEX), having a beneficial balance of unsaturation properties and processability properties, processes for producing crosslinked polyethylene (PEX) from said polyethylene (PE), and the crosslinked polyethylene (PEX) thus produced.

The present invention relates to a polyethylene (PE) for the production of crosslinked polyethylene (PEX), a process for producing such a polyethylene (PE), a process for the production crosslinked polyethylene (PEX) from said polyethylene (PE) and the use of said polyethylene for producing crosslinked polyethylene.

### BACKGROUND TO THE INVENTION

It is known to use crosslinked polyethylene (PEX) for the preparation of pipes. Crosslinked polyethylene can be obtained via different routes. If crosslinking is effected by the use of a peroxide through the so-called Engel process, a crosslinked polyethylene referred to as “PEXa” is obtained. Upon thermal treatment, the peroxide decomposes to radicals which in turn abstract hydrogen atoms from the polymer chains and thereby generate carbon atom radicals within the polymer chains. Carbon atom radicals of neighbouring polymer chains may form a carbon-carbon bond and thereby connect the two polymer chains.

If crosslinking is effected in the presence of a silane, a crosslinked polyethylene referred to as “PEXb” is obtained. Neighbouring polyethylene chains are linked via Si—O—Si bridges.

If crosslinking is effected on the solid pipe via electron beam irradiation, a crosslinked polyethylene referred to as “PEXc” is obtained.

More recently, other PEX technologies have been developed, for examples the so-called Lubonyl process, the polyethylene is crosslinked using pre-added azo compounds after extrusion in a hot salt bath, forming a crosslinked polyethylene referred to as “PEXd”.

Furthermore, various methods that couple the advantages of achieving crosslinking in a molten state, as is the case for PEXa, with the advantages of achieving crosslinking once the article has been formed, as is the case for PEXc, have been developed. One such process, primarily developed by Uponor (SE), involves extruding polyethylene with a photoinitiator and optional crosslinking agent, before a UV-promoted crosslinking step occurs following extrusion in a molten state. Such a process, often referred to as “PEXe”, is described inter alia in WO 2015/162155 A1, WO 2014/177435 A1 and WO 2018/054515 A1. In an alternative process, wherein radical generators are avoided, the polyethylene may be extruded with a crosslinking agent and subsequently crosslinked in an IR oven. Such a process is described in WO 2016/170016 A1.

The choice of polyethylene for use in each of these technologies is a finely balanced science. For PEXa applications, for example, EP 1 587 858 A1 discloses the use of micropellets, which contain polyethylenes having a certain density and MFR₂, for PEXa crosslinking. Whilst these micropellets do have beneficial properties, the use of new polyethylenes in new forms allows for further varied and even improved processes.

So-called PEXe processes demand polyethylenes having a beneficial combination of processability properties (i.e. rheological properties), in order that the molten articles, often pipes, do not sag or deform during the crosslinking in a molten state. Furthermore, due to the nature of the crosslinking under PEXe conditions, certain levels of unsaturation have been found to be beneficial.

Consequently, there remains a need to develop new polyethylene grades that are suitable for newly developed PEXe processes, as well as the more established PEXa processes.

The present invention is based upon such a polyethylene, which is both suitable for processes wherein the crosslinking occurs in a molten state and for more traditional peroxide-based processes, especially when the peroxide is added to the polyethylene in the form of reactor powder.

### SUMMARY OF THE INVENTION

The present invention is consequently directed to a polyethylene (PE) for the production of crosslinked polyethylene (PEX), wherein the polyethylene (PE) fulfils inequation (I):

$$1 \leq UI \times PI < 20 \qquad ( I )$$

wherein the unsaturation index (UI) is defined in Formula (i),

$$UI = \frac{{10}^{7}}{Mw \times [ vinyl ]} \qquad ( i )$$

wherein

Mw is the weight average molecular mass of the polyethylene (PE), measured according to gel permeation chromatography, as expressed in units of g/mol;

[vinyl] is the concentration of vinyl groups per 1000 CHₙ carbons of the polyethylene (PE), as measured by ¹H-NMR spectroscopy;

and the processability index (PI) is defined in Formula (ii):

$$PI = \frac{{MFR}_{21}}{{F}_{120}} \qquad ( ii )$$

wherein

MFR₂₁ is the melt flow rate of the polyethylene (PE), measured according to ISO 1333 at 190° C. at a load of 21.6 kg, as expressed in units of g/10 min;

F₁₂₀ is the melt strength of the polyethylene (PE), measured according to ISO 16790:2021 at a die pressure of 120 bar, as expressed in units of cN.

In a further aspect, the present invention is directed to a first process for the production of crosslinked polyethylene (PEX), comprising the steps of:
a) soaking the polyethylene (PE) of the present invention, in reactor powder form, in liquid peroxide,
b) extruding the soaked polyethylene powder in an extruder, thereby obtaining crosslinked polyethylene (PEX).

In yet another aspect, the present invention is directed to a second process for the production of crosslinked polyethylene (PEX), wherein the crosslinking is achieved through the application of radiation to a composition (C) comprising the polyethylene (PE) of the present invention in a molten state.

In a further aspect, the present invention is directed to a crosslinked polyethylene (PEX) obtainable via the processes of the invention.

In yet a further aspect, the present invention is directed to a crosslinked polyethylene pipe, comprising at least 90 wt.-% of the crosslinked polyethylene (PEX) according to the present invention, wherein the pipe is produced either according to the first process of the present invention, wherein step b) is a pipe extrusion step, or according to the second process of the invention, wherein a pipe extrusion step is carried out prior to the crosslinking step.

In a final aspect, the present invention is directed to a use of the polyethylene (PE) of the present invention for the production of crosslinked polyethylene (PEX).

### Definitions

Unless defined otherwise, all technical and scientific terms used herein have the same meaning as commonly understood by one of ordinary skill in the art to which the invention pertains. Although any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

An ‘ethylene homopolymer’ denotes a polymer consisting essentially of ethylene monomer units. Due to the requirements of large-scale polymerization it may be possible that the ethylene homopolymer includes minor amounts of comonomer units, which usually is below 0.05 mol %, most preferably below 0.01 mol % of the ethylene homopolymer.

A polymer is denoted ‘ethylene copolymer’ if the polymer is derived from ethylene monomer units and at least one alpha-olefin comonomer, wherein the ethylene monomer is present in at least 50 mol %. The alpha-olefin comonomer preferably is typically selected from alpha-olefin comonomers with 4 to 12 carbon atoms (i.e. C4 to C12 alpha olefins).

Following (co)polymerization of ethylene in one or more reactors, the resultant polyethylene is generally removed from the reactor in the form of reactor powder, otherwise known as polyethylene fluff Other forms of polyethylene powder are known, wherein the reactor powder is subsequently pelletized before later being reground into powder form. In the context of the present invention, reactor powder refers to polyethylene powder that has not undergone compounding, extrusion, pelletisation, or any other process whereby the physical form of the reactor powder would be altered.

### DETAILED DESCRIPTION

### The Polyethylene (PE)

The polyethylene (PE) is primarily defined by means of the product of its unsaturation index (UI) and processability index (PI), defined respectively by formulae (i) and (ii):

$$UI = \frac{{10}^{7}}{Mw \times [ vinyl ]} \qquad ( i )$$

$$PI = \frac{{MFR}_{21}}{{F}_{120}} \qquad ( ii )$$

wherein

Mw is the weight average molecular mass of the polyethylene (PE), measured according to gel permeation chromatography, as expressed in units of g/mol;

[vinyl] is the concentration of vinyl groups per 1000 CHₙ carbons of the polyethylene (PE), as measured by ¹H-NMR spectroscopy;

MFR₂₁ is the melt flow rate of the polyethylene (PE), measured according to ISO 1333 at 190° C. at a load of 21.6 kg, as expressed in units of g/10 min; and

F₁₂₀ is the melt strength of the polyethylene (PE), measured according to ISO 16790:2021 at a die pressure of 120 bar, as expressed in units of cN.

The product of the unsaturation index (UI) and processability index (PI) of the polyethylene (PE) must fulfil inequation (I), more preferably inequation (Ia), most preferably inequation (Ib):

$$1.4 \leq UI \times PI < 20 \qquad ( I )$$

$$3 \leq UI \times PI < 17 \qquad ( Ia )$$

$$4 \leq UI \times PI < 15 \qquad ( Ib )$$

It is preferred that the unsaturation index (UI), as defined in Formula (i), of the polyethylene (PE) is in the range from 70 to 103, more preferably in the range from 75 to 102, most preferably in the range from 80 to 100.

It is preferred that the processability index (PI), as defined in Formula (ii), of the polyethylene (PE) is in in the range from 0.02 to 0.20, more preferably in the range from 0.03 to 0.19, most preferably in the range from 0.05 to 0.17.

The MFR₂₁ of the polyethylene (PE), measured according to ISO 1333 at 190° C. at a load of 21.6 kg, is preferably in the range from 2.5 to 30.0 g/10 min, more preferably in the range from 3.0 to 20.0 g/10 min, most preferably in the range from 4.5 to 10.0 g/10 min.

The F₁₂₀ melt strength of the polyethylene (PE), measured according to ISO 16790:2021 at a die pressure of 120 bar, is preferably in the range from 40 to 120 cN, more preferably in the range from 45 to 100 cN, most preferably in the range from 50 to 85 cN.

The weight average molecular mass Mw of the polyethylene (PE), measured according to gel permeation chromatography, is preferably in the range from 150,000 to 300,000 g/mol, more preferably in the range from 170,000 to 270,000 g/mol, most preferably in the range from 200,000 to 250,000 g/mol.

The number average molecular mass Mn of the polyethylene (PE), measured according to gel permeation chromatography, is preferably in the range from 15,000 to 50,000 g/mol, more preferably in the range from 18,000 to 35,000 g/mol, most preferably in the range from 20,000 to 27,000 g/mol.

The z-average molecular mass Mz of the polyethylene (PE), measured according to gel permeation chromatography, is preferably in the range from 1,100,000 to 1,500,000 g/mol, more preferably in the range from 1,150,000 to 1,400,000 g/mol, most preferably in the range from 1,210,000 to 1,300,000 g/mol.

The molecular weight distribution (Mw/Mn) of the polyethylene (PE), measured according to gel permeation chromatography, is preferably in the range from 3 to 20, more preferably in the range from 5 to 15, most preferably in the range from 7 to 12.

The vinyl concentration [vinyl] of the polyethylene (PE), measured by ¹H-NMR spectroscopy, in the range from 0.10 to 2.00 vinyl units per 1000 CHₙ carbons, more preferably in the range from 0.20 to 1.50 vinyl units per 1000 CHₙ carbons, most preferably in the range from 0.30 to 1.00 vinyl units per 1000 CHₙ carbons.

The density of the polyethylene (PE), measured according to ISO 1183, in the range from 935 to 965 kg/m³, more preferably in the range from 945 to 962 kg/m³, most preferably in the range from 950 to 960 kg/m³.

The polyethylene (PE) may be an ethylene homopolymer or a copolymer of ethylene and comonomer(s) selected from C3 to C8 alpha-olefins. If comonomers are present, these must be selected from the group consisting of C3 to C8 alpha-olefins, more preferably C4 to C6 alpha olefins, yet more preferably 1-butene or 1-hexene, most preferably 1-butene.

In the event that a comonomer is present, the total comonomer content is preferably in the range from 0.01 to 1.0 mol %, more preferably in the range from 0.03 to 0.50 mol %, most preferably in the range from 0.05 to 0.20 mol %.

The polyethylene (PE) may be unimodal or multimodal, including bimodal. It is preferred that the polyethylene (PE) is either unimodal or bimodal, most preferably the polyethylene (PE) is unimodal.

In one embodiment, the polyethylene (PE) is provided in the form of a reactor powder or in pellet form. Most preferably, the polyethylene (PE) is provided in the form of a reactor powder.

The polyethylene (PE) reactor powder preferably has a median particle size (D₅₀), measured by sieve analysis, in the range from 400 to 1400 μm, more preferably in the range from 500 to 1200 μm, most preferably in the range from 600 to 1000 μm.

The polyethylene (PE) reactor powder preferably has a top cut particle size (D₉₀), measured by sieve analysis, in the range from 800 to 1400 μm, more preferably in the range from 900 to 1300 μm, most preferably in the range from 1000 to 1200 μm.

The polyethylene (PE) reactor powder preferably has a bottom cut particle size (D₁₀), measured by sieve analysis, in the range from 200 to 500 μm, more preferably in the range from 250 to 450 μm, most preferably in the range from 300 to 400 μm.

The polyethylene (PE) reactor powder preferably has a span of the particle size distribution ((D₉₀−D₁₀)/D₅₀), measured by sieve analysis, in the range from 0.80 to 1.30, more preferably in the range from 0.90 to 1.20, most preferably in the range from 0.95 to 1.10.

The polyethylene (PE) is preferably suitable for the production of crosslinked polyethylene (PEX).

It is preferred that the polyethylene (PE) is suitable for the production of crosslinked polyethylene (PEX) wherein radiation is applied to a composition comprising the polyethylene in a molten state. One such method is known in the field as PEXe.

It is alternatively or additionally preferred that the polyethylene (PE) is suitable for the production of crosslinked polyethylene (PEX) by a method comprising the steps of:
a) soaking the polyethylene (PE), in reactor powder form, in liquid peroxide,
b) extruding the soaked polyethylene powder in an extruder, thereby obtaining crosslinked polyethylene (PEX).

Crosslinked polyethylene (PEX) thus produced is known in the field as PEXa.

All preferable embodiments and fallback positions given below with regard the processes for the production of crosslinked polyethylene (PEX) from the polyethylene (PE) apply mutatis mutandis to the above embodiments wherein the polyethylene (PE) is suitable for such processes.

### Process for Preparing the Polyethylene (PE)

The polyethylene (PE) according to the present invention can be produced by any process known to the person skilled in the art.

Said processes may employ well-known catalysts for ethylene polymerisation, such as single site catalysts and chromium catalysts.

The group of single site catalysts comprises of metallocene and non-metallocene catalysts. By conducting polymerisation in the presence of a single site polymerisation catalyst, optionally in, for example, a solution process, the polyethylene (PE) as described herein, may be produced. The single site catalyst may suitably be a metallocene catalyst. Such catalysts comprise a transition metal compound that contains a cyclopentadienyl, indenyl or fluorenyl ligand. The catalyst contains, e.g., two cyclopentadienyl, indenyl or fluorenyl ligands, which may be bridged by a group preferably containing silicon and/or carbon atom(s). Further, the ligands may have substituents, such as alkyl groups, aryl groups, arylalkyl groups, alkylaryl groups, silyl groups, siloxy groups, alkoxy groups and like. Suitable metallocene compounds are known in the art and are disclosed, among others, in WO-A-97/28170, WO-A-98/32776, WO-A-99/61489, WO-A-03/010208, WO-A-03/051934, WO-A-03/051514, WO-A-2004/085499, EP-A-1752462 and EP-A-1739103.

Especially, the metallocene compound must be capable of producing polyethylene having sufficiently high molecular weight. Especially it has been found that metallocene compounds having hafnium as the transition metal atom or metallocene compounds comprising an indenyl or tetrahydroindenyl type ligand often have the desired characteristics. One example of suitable metallocene compounds is the group of metallocene compounds having zirconium, titanium or hafnium as the transition metal and one or more ligands having indenyl structure bearing a siloxy substituent, such as [ethylenebis(3,7-di(tri-isopropylsiloxy)inden-1-yl)] zirconium dichloride (both rac and meso), [ethylenebis(4,7-di(tri-isopropylsiloxy)inden-1-yl)]zirconium dichloride (both rac and meso), [ethylenebis(5-tert-butyldimethylsiloxy)inden-1-yl)]zirconium dichloride (both rac and meso), bis(5-tert-butyldimethylsiloxy)inden-1-yl)zirconium dichloride, [dimethylsilylenenebis(5-tert-butyldimethylsiloxy)inden-1-yl)] zirconium dichloride (both rac and meso), N-tert-butylamido)(dimethyl)(η5-inden-4-yloxy)silanetitanium dichloride and [ethylenebis(2-(tert-butydimethylsiloxy)inden-1-yl)]zirconium dichloride (both rac and meso).

Another example is the group of metallocene compounds having hafnium as the transition metal atom and bearing a cyclopentadienyl type ligand, such as bis(n-butylcyclopentadienyl)hafnium dichloride, bis(n-butylcyclopentadienyl) dibenzylhafnium, dimethylsilylenenebis(n-butylcyclopentadienyl)hafnium dichloride (both rac and meso) and bis[1,2,4-tri(ethyl)cyclopentadienyl]hafnium dichloride. Still another example is the group of metallocene compounds bearing a tetrahydroindenyl ligand such as bis(4,5,6,7-tetrahydroindenyl)zirconium dichloride, bis(4,5,6,7-tetrahydroindenyl)hafnium dichloride, ethylenebis(4,5,6,7-tetrahydroindenyl)zirconium dichloride, dimethylsilylenebis(4,5,6,7-tetrahydroindenyl)zirconium dichloride.

The single site catalyst typically also comprises an activator. Generally used activators are alumoxane compounds, such as methylalumoxane (MAO), tetraisobutylalumoxane (TIBAO) or hexaisobutylalumoxane (HIBAO). Also boron activators, such as those disclosed in US-A-2007/049711 may be used. The activators mentioned above may be used alone or they may be combined with, for instance, aluminium alkyls, such as triethylaluminium or tri-isobutylaluminium.

Depending on the polymerisation process, the catalyst may be supported. The support may be any particulate support, including inorganic oxide support, for example, silica, alumina or titanium, or a polymeric support, for example, a polymeric support comprising styrene or divinylbenzene. When a supported catalyst is used the catalyst needs to be prepared so that the activity of the catalyst does not suffer. Further, any catalyst residues that remain in a final polymer or product shall also not have any negative impact on the key properties such as, e.g., homogeneity, electrical performance or mechanical properties. The catalyst may also comprise the metallocene compound on solidified alumoxane or it may be a solid catalyst prepared according to emulsion solidification technology. Such catalysts are disclosed, among others, in EP-A-1539775 or WO-A-03/051934.

Chromium catalysts are previously well known, and for detailed description, see M. P. McDaniel, Advances in Catalysis, Vol. 33 (1985), pp 47-98 and M. P. McDaniel, Ind. Eng. Chem. Res., Vol. 27 (1988), pp 1559-1569. Normally, the chromium catalyst is supported by a carrier, preferably silica. The so-called Phillips catalyst, which is based on chromium trioxide on a silica carrier, is a chromium catalyst suitably used in the invention. The Phillips catalyst is generally produced by activating silica together with a so-called master batch of chromium trioxide or chromic acetate. When chromic acetate is used it is oxidised to chromium trioxide, so that the end product is the same no matter whether chromium trioxide or chromic acetate is uses. The chromium trioxide forms volatile chromic acid, which is evenly distributed on the silica particles. The 6-valent chromium deposited on the silica particles should then be reduced in order to become catalytically active, and this happens when the chromium comes into contact with the ethylene in the polymerisation reactor. Further, another type of chromium catalyst that can be used in the present invention is the so-called chromate-type catalyst. When producing such a catalyst, a chromate compound, such as silyl chromate, is deposited on an activated silica carrier. The deposited chromate is reduced by means of an alkoxide, such as an aluminium alkoxide, e.g. diethyl aluminium ethoxide.

The chromium catalyst, in accordance with the present invention, can be modified by titanation and fluoridation, which is in accordance with the prior art (see, for instance, the Preparation of Catalysts, V. G. Oncelet et al, Elsevier Science Publishers, Amsterdam, 1991, pp 215-227, an article by C. 30 E. Marsden).

It is preferred that a chromium catalyst is used for the preparation of the polyethylene (PE).

When the polyethylene (PE) is desired to be a unimodal polyethylene, it can be produced by a single stage polymerisation in a single reactor in a well-known and documented manner. When multimodal (e.g. bimodal) polyethylene is required, it can be produced e.g. by blending mechanically together two or more separate polymer components or, for example, by in-situ blending during the polymerisation process of the components. Both mechanical and in-situ blending are well known in the field.

### Single Site Polyethylene

Accordingly, the exemplified in-situ blending means the polymerisation of the polymer components under different polymerisation conditions, e.g. in a multistage polymerisation reactor system, i.e. two or more stage, or by the use of two or more different single site polymerisation catalysts in a one stage polymerisation, or by use a combination of multistage polymerisation and two or more different single site polymerisation catalysts. In the multistage polymerisation process, the polymer is polymerised in a process comprising at least two polymerisation stages. Each polymerisation stage may be conducted in at least two distinct polymerisation zones in one reactor or in at least two separate reactors.

Furthermore, the multistage polymerisation process may be conducted in at least two cascaded polymerisation zones. Polymerisation zones may be connected in parallel, or, for example, the polymerisation zones operate in cascaded mode.

The polymerisation zones may operate in bulk, slurry, solution, or gas phase conditions or in any combinations thereof. In an exemplified multistage process a first polymerisation step is carried out in at least one slurry, e.g. loop, reactor and the second polymerisation step in one or more gas phase reactors. One exemplified multistage process is described in EP 517868.

In general, the temperature in the single site polyethylene polymerisation, being the low pressure PE polymerisation, is typically from 50 to 115° C., e.g., 60 to 110° C. The pressure is from 1 to 150 bar, for example, 10 to 100 bar. The precise control of polymerisation conditions can be performed by using different types of catalyst and using different comonomer and/or hydrogen feeds.

Further, a single site polyethylene, as described herein, can be prepared by known processes, in a one stage or two stage polymerisation process, utilising solution polymerisation in the presence of a single-site catalyst, e.g. metallocene or constrained geometry catalysts, known to the person skilled in the art.

For example, said single site polyethylene, as described herein, may be prepared by a one stage or two stage solution polymerisation process in a high temperature solution polymerisation process at temperatures higher than 100° C.

Such process is essentially based on polymerising the monomer and a suitable comonomer in a liquid hydrocarbon solvent in which the resulting polymer is soluble. The polymerisation is carried out at a temperature above the melting point of the polymer, as a result of which a polymer solution is obtained. This solution is flashed in order to separate the polymer from the unreacted monomer and the solvent. The solvent is then recovered and recycled in the process. Furthermore, the solution polymerisation process is a high temperature solution polymerisation process using a polymerisation temperature of higher than 100° C. The polymerisation temperature is, for example, at least 110° C., e.g., at least 150° C. The polymerisation temperature can, for example, be up to 250° C. The pressure in such a solution polymerisation process is, for example, in a range of 10 to 100 bar, e.g., 15 to 100 bar and, for example, 20 to 100 bar. The liquid hydrocarbon solvent used is, for example, a C₅₋₁₂-hydrocarbon which may be unsubstituted or substituted by C₁₋₄ alkyl group such as pentane, methyl pentane, hexane, heptane, octane, cyclohexane, methyl cyclohexane and hydrogenated naphtha. For example, unsubstituted C₆₋₁₀-hydrocarbon solvents are used. The precise control of polymerisation conditions can be performed by using different types of catalyst and using different comonomer and/or hydrogen feeds.

A known solution technology suitable for the process to prepare a single site polyethylene in a solution process is the BORCEED™ technology.

### Chromium Catalyst Polyethylene

The chromium catalyst polyethylene being a unimodal low pressure PE can be produced by a single stage polymerisation in a single reactor in a well known and documented manner. The chromium catalyst polyethylene (CrPE) being a multimodal (e.g. bimodal) low pressure PE can be produced e.g. by blending mechanically together two or more separate polymer components or, for example, by in-situ blending during the polymerisation process of the components. Both mechanical and in-situ blending are well known in the field.

Accordingly, the exemplified in-situ blending means the polymerisation of the polymer components under different polymerisation conditions, e.g. in a multistage polymerisation reactor system, i.e. two or more stage, or by the use of two or more different chromium polymerisation catalysts, including multi- or dual site catalysts, in a one stage polymerisation, or by use a combination of multistage polymerisation and two or more different chromium polymerisation catalysts. In the multistage polymerisation process the polymer is polymerised in a process comprising at least two polymerisation stages. Each polymerisation stage may be conducted in at least two distinct polymerisation zones in one reactor or in at least two separate reactors. Furthermore, the multistage polymerisation process may be conducted in at least two cascaded polymerisation zones. Polymerisation zones may be connected in parallel, or, for example, the polymerisation zones operate in cascaded mode. The polymerisation zones may operate in bulk, slurry, solution, or gas phase conditions or in any combinations thereof. In an exemplified multistage process a first polymerisation step is carried out in at least one slurry, e.g. loop, reactor and the second polymerisation step in one or more gas phase reactors. One exemplified multistage process is described in EP517868.

In general, the temperature in the chromium catalyst polyethylene polymerisation, being the low pressure PE polymerisation, is typically from 50 to 115° C., e.g., 60 to 110° C. The pressure is from 1 to 150 bar, for example, 10 to 100 bar. The precise control of polymerisation conditions can be performed by using different types of catalyst and using different comonomer and/or hydrogen feeds.

It is particularly preferred that the polymerisation is carried out in a fluidized bed gas phase reactor.

In a fluidized bed gas phase reactor an olefin is polymerised in the presence of a polymerisation catalyst in an upwards moving gas stream. The reactor typically contains a fluidized bed comprising the growing polymer particles containing the active catalyst located above a fluidization grid. The polymer bed is fluidized with the help of the fluidization gas comprising the olefin monomer, eventual comonomer(s), eventual chain growth controllers or chain transfer agents, such as hydrogen, and eventual inert gas. The fluidization gas is introduced into an inlet chamber at the bottom of the reactor. One or more of the above-mentioned components may be continuously added into the fluidization gas to compensate for losses caused, among other, by reaction or product withdrawal. From the inlet chamber the gas flow is passed upwards through a fluidization grid into the fluidized bed. The fluidization gas passes through the fluidized bed. The superficial velocity of the fluidization gas must be higher than the minimum fluidization velocity of the particles contained in the fluidized bed, as otherwise no fluidization would occur. On the other hand, the velocity of the gas should be lower than the onset velocity of pneumatic transport, as otherwise the whole bed would be entrained with the fluidization gas.

When the fluidization gas is contacted with the bed containing the active catalyst, the reactive components of the gas, such as monomers and chain transfer agents, react in the presence of the catalyst to produce the polymer product, i.e. the chromium catalyst polyethylene. At the same time the gas is heated by the reaction heat. The unreacted fluidization gas is removed from the top of the reactor and cooled in a heat exchanger to remove the heat of reaction. The gas is cooled to a temperature which is lower than that of the bed to prevent the bed from heating because of the reaction. It is possible to cool the gas to a temperature where a part of it condenses. When the liquid droplets enter the reaction zone they are vaporised. The vaporisation heat then contributes to the removal of the reaction heat. The condensing agents are non-polymerisable components, such as n-pentane, isopentane, n-butane or isobutane, which are at least partially condensed in the cooler. The gas is then compressed and recycled into the inlet chamber of the reactor. Prior to the entry into the reactor fresh reactants are introduced into the fluidization gas stream to compensate for the losses caused by the reaction and product withdrawal. It is generally known how to analyze the composition of the fluidization gas and to introduce the gas components to keep the composition constant. The actual composition is determined by the desired properties of the product and the catalyst used in the polymerisation.

The catalyst may be introduced into the reactor in various ways, either continuously or intermittently. The polymeric product may be withdrawn from the gas phase reactor either continuously or intermittently. Combinations of these methods may also be used.

Typically, the fluidized bed polymerisation reactor is operated at a temperature within the range of from 50 to 110° C., preferably from 65 to 110° C. The pressure is suitably from 10 to 40 bar, preferably from 15 to 30 bar.

A known gas phase technology suitable for the process to prepare a chromium catalyst polyethylene in a fluidized bed gas phase process is the UNIPOL™ technology.

Prepolymerisation may precede the actual polymerisation step(s) of the polyethylene (PE), as well known in the field.

The polyethylene powder removed from the reactors may be pelletized with optional additives; however, it is preferred that the polyethylene powder is not pelletized before the PEX-forming process of the present invention, i.e. that reactor powder is used in these PEX-forming processes as described below.

As an alternative method for additivation, the optional additives can be added to the reactor powder via a melt-spray system.

Typical additives may be selected from the group consisting of antioxidants, stabilizers, nucleating agents and antistatic agents. Such additives are generally commercially available and are described, for example, in “Plastic Additives Handbook”, pages 871 to 873, 5th edition, 2001 of Hans Zweifel.

Processes for the Production of Crosslinked Polyethylene (PEX) from the Polyethylene (PE)

The present invention is further directed to a process for the production of crosslinked polyethylene (PEX) from the inventive polyethylene (PE).

A wide range of possible crosslinking technologies are known in the art and the inventive polyethylene (PE) can be used for each such technology. Examples of the different methods include peroxide-promoted crosslinking (so-called PEXa), silanol condensation-based cross linking (so-called PEXb), electron beam crosslinking (so-called PEXc), azo coupling (so-called PEXd) or crosslinking using UV treatment in a molten state (so-called PEXe), in addition to many other recently developed technologies.

The polyethylene (PE) according to the present invention is particularly suitable for methods wherein radiation is applied to the polyethylene (PE) in a molten state. Such methods include, but are not limited to, PEXe-type processes wherein UV light is applied to a composition comprising the polyethylene (PE) and a photoinitiator, or alternatively a composition containing the polyethylene (PE) and a crosslinking agent (e.g. a diene) can be heated in an IR oven (i.e. IR radiation is applied) to achieve the crosslinking.

In one embodiment, the present invention is directed to a process for the production of crosslinked polyethylene (PEX), wherein the crosslinking is achieved through the application of radiation to a composition (C) comprising the polyethylene (PE) in a molten state.

In one preferred embodiment, the composition (C) further comprises a photoinitiator and an optional crosslinking agent, whilst the radiation applied to the molten composition is UV radiation.

The photoinitiator can be any photoinitiator that is capable of being activated upon exposure to radiation, i.e. upon exposure to UV A, UV B, UV C and the entire visible range, preferably UVA and the visible range, more preferably 355-420 nm.

Exemplary free radical photoinitiators suitable for the process according to the present invention include:
(i) acyl- and bisacylphosphine oxides such as 2,4,6-trimethylbenzoyl di-phenylphosphine oxide, bis-(2,4,6-trimethylbenzoyl)phenylphosphine oxide;
(ii) anisoin;
(iii) benzoin and benzoin alkyl ether, such as benzoin ethyl ether, benzoin isobutyl ether, benzoin methyl ether;
(iv) benzil and benzil dialkyl ketals such as benzil dimethyl ketal;
(v) acetophenone; hydroxyacetophenones such as 1-hydroxycyclohexyl phenyl ketone, 2-hydroxy-2-methyl-1-phenyl-1-propanone, 2-hydroxy-1-[4-(2-hydroxyethoxy)-phenyl]-2-methyl-1-propanone, 3′-hydroxyacetophenone, 4′-hydroxyacetophenone, 2-hydroxy-2-methylpropiophenone; (di)alkoxyacetophenones such as 2,2-diethoxyacetophenone, 2,2-dimethoxy-2-phenylacetophenone, 4′-ethoxyacetophenone; aminoacetophenones such as 2-benzyl-2-(dimethylamino)-1-[4-(4-morpholinyl)-phenyl]-1-butanone, 2-methyl-1-[4-(methylthio)-phenyl]-2-(4-morpholinyl)-1-propanone; aryloxyacetophenones such as 4′-phenoxyacetophenone;
(vi) benzophenone, 3,3′,4,4′-benzophenonetetracarboxylic dianhydride, benzoylbiphenyl, (di)hydroxybenzophenones, such as 4′-dihydroxybenzophenone, 3-hydroxybenzophenone, 4-hydroxybenzophenone; (di)alkoxybenzophenones, such as4′-dimethoxybenzophenone, 3-methoxybenzophenone, 4-methoxybenzophenone; and (di)alkylbenzophenones, such as 4-(dimethylamino) benzophenone, 2-methylbenzophenone, 3-methylbenzophenone, 2,5-dimethylbenzophenone, 3,4-dimethylbenzophenone, (di)aminobenzophenones, such as 4,4′-bis(dimethylamino) benzophenone, and 2-benzyl-2-(dimethylamino)-4′-morpholinobutyrophenone, 2-methyl-4′-(methylthio)-2-morpholinopropiophenone;
(vii) anthraquinone and alkyl anthraquinones, such as 2-ethylanthraquinone;
(viii) thioxanthones; alkylthioxanthones such as i-propylthioxanthone; and thioxanthen-9-ones such as 2-chlorothioxanthen-9-one;
(ix) dibenzosuberenone;
(x) a-Diketones such as camphorquinone, 9,10-phenanthrenequinone, 1-phenyl-propane-1,2-dione, 4,4′-dichlorobenzil, methybenzoylformate or their derivatives;
(xi) monoacyl- and diacylgermanium compounds such as benzoyltrimethylgermanium, dibenzoyldiethylgermanium, bis-(4-methoxybenzoyl)-diethylgermanium;
(xii) titanocenes such as bis-(eta⁵-2,4-cyclopentadien-1-yl)-bis-[2,6-difluoro-3-(1H-pyrrol-1-yl)phenyl]-titanium.

Particular examples are acetophenone, anisoin, anthraquinone, benzil, benzoin, benzoin ethyl ether, benzoin isobutyl ether, benzoin methyl ether, benzophenone, 1-hydroxycyclohexyl phenyl ketone, 3,3′,4,4′-benzophenonetetracarboxylic dianhydride, benzoylbiphenyl, 2-benzyl-2-(dimethylamino)-4′-morpholinobutyrophenone, 4,4′-bis(diethylamino)benzophenone, 4,4′-bis(dimethylamino) benzophenone, camphorquinone, 2-chlorothioxanthen-9-one, dibenzosuberenone, 2,2-diethoxyacetophenone, 4,4′-dihydroxybenzophenone, 2,2-dimethoxy-2-phenylacetophenone, 4-(dimethylamino) benzophenone, 4,4′-dimethylbenzil, 2,5-dimethylbenzophenone, 3,4-dimethylbenzophenone, diphenyl(2,4,6-trimethylbenzoyl) phosphine oxide/2-hydroxy-2-methylpropiophenone, 4′-ethoxyacetophenone, 2-ethylanthraquinone, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, and thioxanthen-9-one.

It is particularly preferred that benzophenone-based photoinitiators are used, most preferably the photoinitiator is an alkoxy-substituted benzophenone.

The photoinitiator is preferably present in the composition in an amount from 0.02 to 3.0 wt.-%, more preferably in an amount from 0.2 to 2.5 wt.-%, most preferably in an amount from 0.5 to 2.0 wt.-%.

The crosslinking agent may be any suitable crosslinking agent having at least two reactive groups suitable for crosslinking, most preferably two olefin groups.

The particular choice of crosslinking agent is not particularly limited and suitable crosslinking agents are listed in WO 2015/162155 A1.

The crosslinking agent is preferably present in the composition in an amount from 0.02 to 3.0 wt.-%, more preferably in an amount from 0.2 to 2.5 wt.-%, most preferably in an amount from 0.5 to 2.0 wt.-%.

In an alternative embodiment, the composition (C) further comprises a crosslinking agent and the radiation applied to the molten composition is IR radiation.

The crosslinking agent according to this embodiment may be any suitable crosslinking agent having at least two reactive groups suitable for crosslinking, most preferably two olefin groups.

It is particularly preferred that the crosslinking agent is a bismaleimido crosslinker, most preferably hexamethylene-1,6-dimaleimide (CAS 4856-87-5).

The crosslinking agent is preferably present in the composition in an amount from 0.02 to 5.0 wt.-%, more preferably in an amount from 0.2 to 3.0 wt.-%, most preferably in an amount from 0.5 to 2.5 wt.-%.

Further details of the IR irradiation crosslinking can be found in WO 2016/170016 A1.

In each of the embodiments described above, the radiation is preferably applied to the composition (C) comprising the polyethylene (PE) in a molten state following extrusion.

It is particularly preferred that the composition (C) is extruded to form pipes, which are subsequently crosslinked via the application of the radiation in a molten state.

Consequently, the process may comprise the following steps:
a) addition of the inventive polyethylene (PE) with optional photoinitiator, optional crosslinking agent and optional additives into an extruder, preferably a twin-screw extruder;
b) blending and extruding of the resultant composition (C) to form an extruded article, preferably an extruded pipe;
c) applying radiation to the extruded article, preferably the extruded pipe, thereby crosslinking the polyethylene (PE) in a molten state to form crosslinked polyethylene (PEX); and
d) cooling the article, preferably pipe, containing the crosslinked polyethylene (PEX) to form a solid article, preferably a solid pipe.

In one embodiment, the process may comprise the following steps:
a) addition of the inventive polyethylene (PE) with a photoinitiator, optional crosslinking agent and optional additives into an extruder, preferably a twin-screw extruder;
b) blending and extruding of the resultant composition (C) to form an extruded article, preferably an extruded pipe;
c) applying UV radiation to the extruded article, preferably the extruded pipe, thereby crosslinking the polyethylene (PE) in a molten state to form crosslinked polyethylene (PEX); and
d) cooling the article, preferably pipe, containing the crosslinked polyethylene (PEX) to form a solid article, preferably a solid pipe.

In an alternative embodiment, the process may comprise the following steps:
a) addition of the inventive polyethylene (PE) with crosslinking agent and optional additives into an extruder, preferably a twin-screw extruder;
b) blending and extruding of the resultant composition (C) to form an extruded article, preferably an extruded pipe;
c) applying IR radiation to the extruded article, preferably the extruded pipe, thereby crosslinking the polyethylene (PE) in a molten state to form crosslinked polyethylene (PEX); and
d) cooling the article, preferably pipe, containing the crosslinked polyethylene (PEX) to form a solid article, preferably a solid pipe.

The composition used in PEX processes often contains further stabilising additives such as antioxidants, UV absorbers, quenchers, hindered amine light stabilizers (HALS), acid scavengers, and heat stabilisers. The selection of suitable additives falls within the general knowledge and skills of the person skilled in the art.

The polyethylene (PE) according to the present invention is also suitable for use in polyethylene crosslinking processes employing thermally activated radical initiators, such as peroxide-based radical initiators (PEXa) or azo-based radical initiators (PEXd).

It is a finding of the present invention that when the inventive polyethylene (PE) is used in the form of a reactor powder, these processes are especially effective.

The present invention is thus also directed to a process for the producing of crosslinked polyethylene (PEX), comprising the steps of:
a) soaking the inventive polyethylene (PE) in the form of a reactor powder in liquid peroxide or a peroxide solution,
b) extruding the soaked polyethylene powder in an extruder, preferably a twin-screw extruder, thereby obtaining crosslinked polyethylene (PEX).

As is well known in the field of crosslinked polyethylene, such PEXa-type processes typically require high temperatures in the range from 160 to 260° C., more preferably in the range from 180 to 255° C., most preferably in the range from 200 to 250° C. in the extruder, preferably twin-screw extruder.

Appropriate peroxides, in particular organic peroxides, by which crosslinking of polyethylene can be effected are known to the skilled person. One or more of the following organic peroxides might be used:

Dicumyl peroxide, benzoyl peroxide, dichlorobenzoyl peroxide, di-tert-butylperoxide, 2,5-dimethyl-2,5di(peroxybenzoate), hexyne-3,1,4-bis(tert-butylperoxyisopropyl)benzene, lauroyl peroxide, tert-butyl peracetate, tert-butyl perbenzoate, 2,5-dimethyl-2,5-di(tert-butylperoxy)hexane, 2,5-dimethyl-2,5-di(tert-butylperoxy)hexyne and tert-butylperphenyl acetate.

In principle, the crosslinkable composition may additionally comprise a non-peroxide crosslinking agent. However, in a preferred embodiment, crosslinking is effected in the absence of a non-peroxide crosslinking agent.

All preferable embodiments and fallback positions for the polyethylene (PE), the polyethylene reactor powder and the process for preparing the polyethylene (PE) may apply mutatis mutandis to the processes for the production of crosslinked polyethylene (PEX) from the polyethylene (PE) of the present invention.

The present invention is further directed to a crosslinked polyethylene (PEX) obtainable via the processes of the invention.

The crosslinked polyethylene (PEX) preferably has a crosslinking degree of at least 40%, more preferably at least 50%, most preferably at least 60%.

All preferable embodiments and fallback positions for the polyethylene (PE), the polyethylene reactor powder, the process for preparing the polyethylene (PE) and the processes for the production of crosslinked polyethylene (PEX) from the polyethylene (PE) may apply mutatis mutandis to the obtained crosslinked polyethylene (PEX) of the present invention.

### Articles and Use

The present invention is further directed to a crosslinked polyethylene pipe comprising at least 90 wt.-% of the crosslinked polyethylene (PEX) as described in the previous sections.

In one embodiment, the crosslinked pipe is produced via a PEXa-type process.

In this embodiment, the extrusion step b) is a pipe extrusions step.

Consequently, the crosslinked pipe may be produced by a process comprising the steps of:
a) soaking the inventive polyethylene (PE) in the form of a reactor powder in liquid peroxide or a peroxide solution,
b) extruding the soaked polyethylene powder in an extruder, preferably a twin-screw extruder, to form a pipe, thereby obtaining a crosslinked polyethylene pipe.

In an alternative embodiment, the crosslinked pipe is produced via a process involving the application of radiation to the extruded pipe in a molten state.

In this embodiment, a pipe extrusion step is carried out prior to the crosslinking step.

Consequently, the crosslinked pipe may be produced by a process comprising the steps of:
a) addition of the inventive polyethylene (PE) with optional photoinitiator, optional crosslinking agent and optional additives into an extruder, preferably a twin-screw extruder;
b) blending and extruding of the resultant composition (C) to form an extruded pipe;
c) applying radiation to the extruded pipe, thereby crosslinking the polyethylene (PE) in a molten state to form crosslinked polyethylene (PEX); and
d) cooling the pipe containing the crosslinked polyethylene (PEX) to form a solid pipe.

In one embodiment, the process may comprise the following steps:
a) addition of the inventive polyethylene (PE) with a photoinitiator, optional crosslinking agent and optional additives into an extruder, preferably a twin-screw extruder;
b) blending and extruding of the resultant composition (C) to form an extruded pipe;
c) applying UV radiation to the extruded pipe, thereby crosslinking the polyethylene (PE) in a molten state to form crosslinked polyethylene (PEX); and
d) cooling the pipe containing the crosslinked polyethylene (PEX) to form a solid pipe.

In an alternative embodiment, the process may comprise the following steps:
a) addition of the inventive polyethylene (PE) with crosslinking agent and optional additives into an extruder, preferably a twin-screw extruder;
b) blending and extruding of the resultant composition (C) to form an extruded pipe;
c) applying IR radiation to the extruded pipe, thereby crosslinking the polyethylene (PE) in a molten state to form crosslinked polyethylene (PEX); and
d) cooling the pipe containing the crosslinked polyethylene (PEX) to form a solid pipe.

The present invention is furthermore directed to a use of the inventive polyethylene (PE) for the production of crosslinked polyethylene (PEX).

Preferably the use of the inventive polyethylene (PE) according to the present invention is for the production of a crosslinked polyethylene pipe.

All preferable embodiments and fallback positions for the polyethylene (PE), the process for preparing the polyethylene (PE), and the processes for the production of crosslinked polyethylene (PEX) from the polyethylene (PE) may apply mutatis mutandis to the use of the present invention.

1: A polyethylene (PE) for the production of crosslinked polyethylene (PEX), wherein the polyethylene (PE) fulfils inequation (I):
$$1.4 \leq UI \times PI < 20 \qquad ( I )$$
wherein the unsaturation index (UI) is defined in Formula (i),
$$UI = ( 10 \hat{} 7 ) / ( Mw \times [ vinyl ] ) \qquad ( i )$$
wherein
Mw is the weight average molecular mass of the polyethylene (PE), measured according to gel permeation chromatography, as expressed in units of g/mol;
[vinyl] is the concentration of vinyl groups per 1000 CHₙ carbons of the polyethylene (PE), as measured by ¹H-NMR spectroscopy;
and the processability index (PI) is defined in Formula (ii):
$$PI = {MFR}_{21} / {F}_{120} \qquad ( ii )$$
wherein
MFR₂₁ is the melt flow rate of the polyethylene (PE), measured according to ISO 1333 at 190° C. at a load of 21.6 kg, as expressed in units of g/10 min;
F₁₂₀ is the melt strength of the polyethylene (PE), measured according to ISO 16790:2021 at a die pressure of 120 bar, as expressed in units of cN.

2: The polyethylene (PE) according to claim 1, having an unsaturation index (UI), as defined in Formula (i), in the range from 70 to 103.

3: The polyethylene (PE) according to claim 1, having a processability index (PI), as defined in Formula (ii), in the range from 0.02 to 0.20.

4: The polyethylene (PE) according to claim 1, having a melt flow rate MFR₂₁, measured according to ISO 1333 at 190° C. at a load of 21.6 kg, in the range from 2.5 to 30.0 g/10 min.

5: The polyethylene (PE) according to claim 1, having an F₁₂₀ melt strength, measured according to ISO 16790:2021 at a die pressure of 120 bar, in the range from 40 to 120 cN.

6: The polyethylene (PE) according to claim 1, having a weight average molecular mass Mw, measured according to gel permeation chromatography, in the range from 150,000 to 300,000 g/mol.

7: The polyethylene (PE) according to claim 1, having a vinyl concentration [vinyl], measured by ¹H-NMR spectroscopy, in the range from 0.10 to 2.00 vinyl units per 1000 CHₙ carbons.

8: The polyethylene (PE) according to claim 1, having a molecular weight distribution (Mw/Mn), measured according via gel permeation chromatography, in the range from 3 to 20.

9: The polyethylene (PE) according to claim 1, having a density, measured according to ISO 1183, in the range from 935 to 965 kg/m³.

10: A process for the production of crosslinked polyethylene (PEX), comprising the steps of:
a) soaking polyethylene (PE) according to claim 1, in reactor powder form, in liquid peroxide or a peroxide solution,
b) extruding the soaked polyethylene powder in an extruder, thereby obtaining crosslinked polyethylene (PEX).

11: A process for the production of crosslinked polyethylene (PEX), wherein the crosslinking is achieved through the application of radiation to a composition (C) comprising the polyethylene (PE) according to any one of claim 1 in a molten state.

12: The process for the production of crosslinked polyethylene (PEX) according to claim 11, wherein the composition (C) further comprises a photoinitiator and the radiation applied to the molten composition is UV radiation.

13: The crosslinked polyethylene (PEX) obtainable via the process of claim 10.

14: A crosslinked polyethylene pipe, comprising at least 90 wt.-% of the crosslinked polyethylene (PEX) according to claim 13, wherein the pipe is produced either according to claim 10 wherein extrusion step b) is a pipe extrusion step.

15. (canceled)

16: A crosslinked polyethylene pipe, comprising at least 90 wt. % of the crosslinked polyethylene (PEX) according to claim 13, wherein the pipe is produced according to claim 11 wherein a pipe extrusion step is carried out prior to the crosslinking step.
